(19) United States
(12) Patent Application Publication
(10) Pub. No.: US 2004/0105377 A1
(43) Pub. Date: Jun. 3, 2004

(54) Optical pickup and disk drive unit

(76) Inventors: Tadashi Taniguchi, Kanagawa (JP); Kiyoshi Yamauchi, Kanagawa (JP)

Correspondence Address: Ronald P Kananen, Rader Fishman & Grauer, The Lion Building Suite 501, 1233 20th Street NW, Washington, DC, 20036, US

(21) Appl. No.: 10/471,789

(22) PCT Filed: Jan. 30, 2003
(86) PCT No.: PCT/JP03/00940

(30) Foreign Application Priority Data
Feb. 8, 2002 (JP) 2002-31749

(51) Int. Cl. G11B 7/135

(52) U.S. Cl. 369/112.29

(57) ABSTRACT

An optical pickup and a disk drive apparatus, each having a reduced number of components and a reduced size, is provided with a light emitting element (11); a rise mirror (12) which includes a main portion (17) having an inclined surface (17a) formed at a predetermined angle with respect to the optical axis of a laser beam emitted from the light emitting element and which includes a half mirror (18) disposed on the inclined surface, for reflecting at least a part of the laser beam toward a disk recording medium (100); and a receiving optics (15) for receiving the laser beam reflected at the disk recording medium, and also is provided with detecting means (19) disposed in the rise mirror, for receiving a part of the laser beam emitted from the light emitting element and also for detecting the output of the received laser beam.

### TECHNICAL FIELD

The present invention relates to optical pickups and disk drive apparatuses, and more particularly, it relates to an optical pickup for recording and playing back an information signal into and from a disk-shaped recording medium placed on a disk table and also a disk drive apparatus including the optical pickup.

### BACKGROUND ART

There is a disk drive apparatus for recording and playing back an information signal into and from a disk-shaped recording medium that includes an optical pickup moving in the radial direction of the disk recording medium placed on a disk table and irradiating the disk recording medium with a laser beam.

The optical pickup has predetermined optical constituents (optical elements and optical components) and the like disposed on a moving base moving in the radial direction of the disk recording medium. Another optical pickup has a front photo diode having an APC (automatic power control) function for controlling the amount of a laser beam emitted from a light emitting element so as to be constant.

Each of the optical constituents disposed in the moving base and the optical path of the laser beam of the known optical pickup having the APC function will be described below (see FIG. 9).

A light emitting element a is mounted on a circuit board (not shown) having a mount b, called a sub-mount, interposed therebetween. The light emitting element a is of a so-called side light-emitting type which emits a laser beam sidewards; and a laser beam emitted from the light emitting element a is split into a reflected beam and a transmitted beam, respectively, and reflected at and transmitted through a half mirror d formed on a rise mirror c.

The laser beam reflected at the half mirror d has its light path bent at 90 degrees and is incident on a collimator lens e.

The laser beam incident on the collimator lens e forms a parallel flux and is incident on a beam splitter f. The laser beam incident on the beam splitter f is transmitted through a split surface g toward an objective lens h and is collected on a recording surface of a disk recording medium i by the objective lens h.

The leaser beam collected on the recording surface of the disk recording medium i is reflected at the recording surface and, as a return beam, is incident again on the beam splitter f via the objective lens h. The return beam incident on the beam splitter f has its light path bent at 90 degrees by the split surface g and is incident on a receiving optics j. Upon being incident on the receiving optics j, the return beam is subjected to a photoelectric conversion and is output as an electric signal; thus, for example, an information signal recorded in the disk recording medium i is played back.

Meanwhile, the laser beam transmitted through the half mirror d of the rise mirror c is incident on a collective lens k. The laser beam incident on the collective lens k is collected and incident on a front photo diode l disposed as detecting means for controlling the output of the laser beam emitted from the light-emitting element a. The amount of the laser beam incident on the front photo diode l is detected, and, in accordance with the detected amount, the output of the light emitting element a is controlled so as to make the amount of the laser beam emitted from the light emitting element a constant.

Whereas, in the above-described, known disk drive apparatus, the front photo diode l is disposed independently from the remaining optical constituents, thereby causing the number of components of the disk drive apparatus to increase by that much, and also, an exclusive disposing space for the front photo diode l is needed in the moving base of the optical pickup, thereby resulting in large sizes of the optical pickup and the disk drive apparatus.

Also, since the laser beam transmitted through the rise mirror c diverges as it travels farther away from the rise mirror c, the collective lens l is needed to make this diverging beam effectively incident on the photo diode 1, thereby further increasing the numbers of components and resulting in larger sizes of the optical pickup and the disk drive apparatus.

The other optical pickup provided with the APC function has a structure, as shown in FIG. 10, in which a total reflecting mirror n is formed on a rise mirror m, and a part of a laser beam emitted from the light emitting element a, with which the total reflecting mirror n is not irradiated, is collected on the front photo diode 1 via the collective lens k so as to control the amount of the laser beam emitted from the light emitting element a.

However, even when the total reflecting mirror n is used as described above, since the front photo diode l is disposed independently from the remaining optical constituents and also the collective lens k is needed, the numbers of components of the optical pickup and the disk drive apparatus increase and the sizes of the same become larger.

Accordingly, the objects of the optical pickup and the disk drive apparatus according to the present invention are to solve the above problems and to reduce the numbers of components and the sizes thereof.

### DISCLOSURE OF INVENTION

In order to solve the above mentioned problems, an optical pickup and a disk drive apparatus according to the present invention include a light emitting element for emitting a laser beam, a rise mirror including a main portion, having an inclined surface formed at a predetermined angle with respect to the optical axis of a laser beam emitted from the light emitting element, and a mirror portion formed on the inclined surface, for reflecting at least a part of the laser beam emitted from the light emitting element toward the disk recording medium, and a receiving optics for receiving the laser beam that is reflected at the rise mirror, with which the disk recording medium is subsequently irradiated, and which is then reflected at the disk recording medium. The rise mirror has at least one unit of detecting means disposed therein for receiving a part of the laser beam emitted from the light emitting element, for detecting the output of the received laser beam, and for outputting a signal for controlling the output of the light emitting element in accordance with the detected result.

Accordingly, the optical pickup and the disk drive apparatus according to the present invention have the rise mirror that is provided additionally with a function of controlling the output of the light emitting element.

### BRIEF DESCRIPTION OF THE DRAWINGS

FIG. 1 is a schematic perspective view of a disk drive apparatus, illustrating an embodiment of the present invention, together with FIGS. 2 and 8.

FIG. 2 is a conceptual diagram illustrating optical constituents disposed in the disk drive apparatus.

FIG. 3 is a magnified side view illustrating a first modification of a rise mirror, together with FIG. 4.

FIG. 4 is an illustration viewed from the arrow X indicated in FIG. 3.

FIG. 5 is a magnified side view illustrating a second modification of the rise mirror, together with FIG. 6.

FIG. 6 is an illustration viewed from the arrow Y indicated in FIG. 5.

FIG. 7 is a magnified side view illustrating a rise mirror having a main portion and detecting means composed of different members from each other.

FIG. 8 is a magnified side view illustrating an example of one unit into which a mount and a main portion of a rise mirror are integrated.

FIG. 9 is a conceptual diagram illustrating optical constituents disposed in a known disk drive apparatus.

FIG. 10 is a conceptual diagram illustrating other optical constituents disposed in another known disk drive apparatus.

### BEST MODE FOR CARRYING OUT THE INVENTION

An embodiment of an optical pickup and a disk drive apparatus according to the present invention will be described with reference to the accompanying drawings.

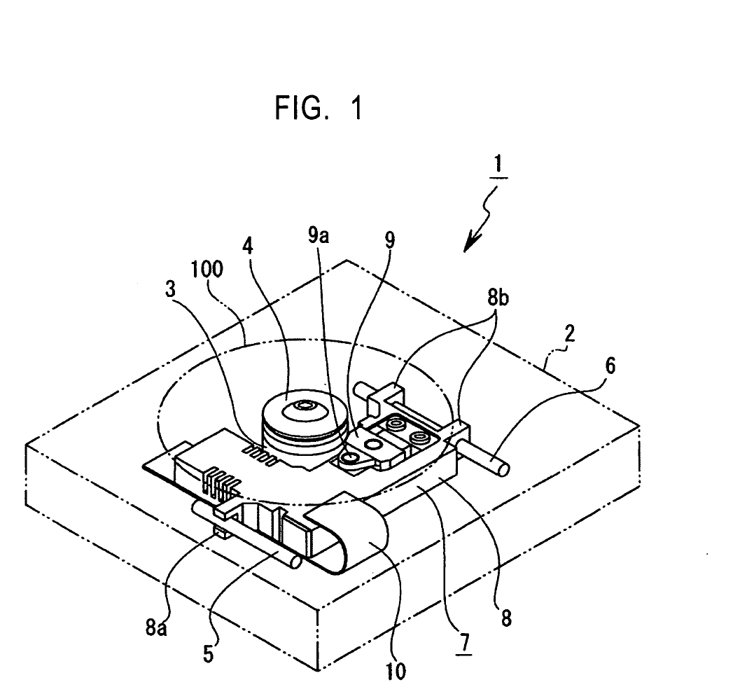

A disk drive apparatus 1 has necessary members and mechanisms disposed in an outer casing 2 (see FIG. 1), and the outer casing 2 has a disk slot (not shown) which is wider than it is long.

The outer casing 2 has a chassis (not shown) disposed therein, and the chassis has a spindle motor 3 fixed thereto. The spindle motor 3 has a disk table 4 firmly fixed to its motor shaft.

The chassis has guide shafts 5 and 6 fixed thereto, which are parallel to each other, and has a lead screw (not shown) supported thereby, which is turned by a feed motor (not shown).

An optical pickup 7 has a moving base 8, necessary optical constituents (optical elements and optical components) disposed in the moving base 8, and a biaxial actuator 9 supported in the moving base 8; and the moving base 8 has bearing units 8a and 8b formed at both ends thereof, which are slidably supported by the guide shafts 5 and 6, respectively. When a nut member (not shown) formed in the moving base 8 is screwed with the lead screw and the lead screw is turned by the feed motor, the nut member is forwarded in a direction depending on the turning direction of the lead screw; thus, the optical pickup 7 is moved in the radial direction of a disk recording medium 100 placed on the disk table 4.

One terminal of a flexible printed wiring board 10 is connected to the moving base 8, and the other terminal of the flexible printed wiring board 10 is connected to a drive-control circuit board (not shown) formed in the outer casing 2. Accordingly, the biaxial actuator 9 of the optical pickup 7, each of the optical elements, and the like are supplied with electric power, and they transact a variety of signals through the flexible printed wiring board 10.

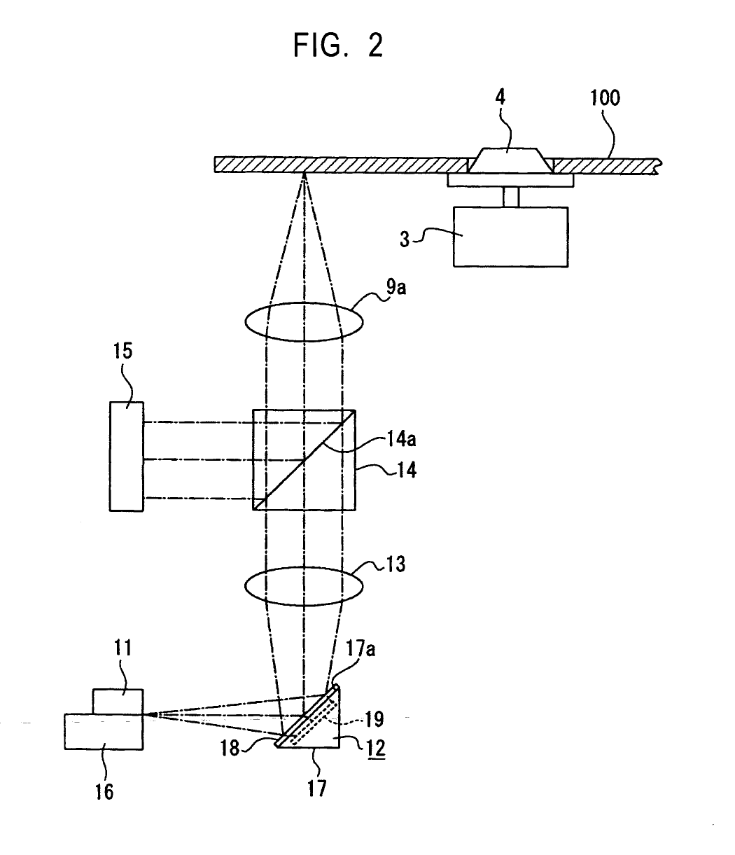

The moving base 8 has the necessary optical constituents disposed therein (see FIG. 2).

The optical constituents include a light emitting element 11, a rise mirror 12, a collimator lens 13, a beam splitter 14, an objective lens 9a of the biaxial actuator 9, and a receiving optics 15, each disposed in place.

The light emitting element 11 is mounted on a circuit board (not shown) having a mount 16 that is called a sub-mount. For example, a side light-emitting laser diode which emits a laser beam sidewards is used as the light emitting element 11. In order to prevent a laser beam emitted from the light emitting element 11 from becoming noise against the circuit board when the laser beam is reflected thereat, the mount 16 is disposed, for example, so as to space the light emitting element 11 away from the circuit board, with the light emitting element 11 being placed high.

The rise mirror 12 has a main portion 17 having a triangular prism shape and a half mirror 18 serving as a mirror portion and formed on an inclined surface 17a of the main portion 17. The inclined surface 17a of the main portion 17 is placed at an angle of, for example, 45 degrees with respect to the light path of a laser beam emitted from the light emitting element 11.

The main portion 17 is composed of a semiconductor material such as silicon (Si). The main portion 17 has a photo diode 19 disposed therein in a buried manner, serving as detecting means for detecting the output of the light emitting element 11. The photo diode 19 is formed so as to have, for example, a round shape and is disposed so as to extend along the inclined surface 17a in the vicinity of the inclined surface 17a of the main portion 17.

The photo diode 19 is composed of the same material as that of the main portion 17. Since the main portion 17 and the photo diode 19 are composed of the same material as mentioned above, the rise mirror 12 can be very easily formed at a low cost.

The half mirror 18 is formed on almost the entire inclined surface 17a of the main portion 17. Accordingly, the half mirror 18 is disposed across the entire irradiation region of the rise mirror 12, irradiated with a laser beam emitted from the light emitting element 11. The photo diode 19 disposed in the main portion 17 is entirely covered by the half mirror 18.

When a laser beam is emitted from the light emitting element 11, the emitted laser beam is split into a reflected beam and a transmitted beam by the half mirror 18 of the rise mirror 12.

The laser beam reflected at the half mirror 18 has its light path bent at 90 degrees and is incident on the collimator lens 13.

The laser beam incident on the collimator lens 13 becomes a parallel flux and is incident on the beam splitter 14. The laser beam incident on the beam splitter 14 is transmitted through a split surface 14a toward the objective lens 9a of the biaxial actuator 9 and is collected by the objective lens 9a on a recording surface of the turning disk-recording-medium 100 placed on the disk table 4.

The laser beam collected on the recording surface of the disk recording medium 100 is reflected at the recording surface and, as a return beam, is again incident on the beam splitter 14 via the objective lens 9a. The return beam incident on the beam splitter 14 has its light path bent at 90 degrees at the split surface 14a and is incident on the receiving optics 15. Upon being incident on the receiving optics 15, the return beam is subjected to a photoelectric conversion and is output as an electric signal; thus, for example, an information signal recorded in the disk recording medium 100 is played back.

In the meantime, the laser beam transmitted through the half mirror 18 of the rise mirror 12 is incident on the photo diode 19. When the laser beam is incident on the photo diode 19, its amount is detected, and the output of the light emitting element 11 is controlled so as to make the amount of the laser beam emitted from the light emitting element 11 constant in accordance with the detected amount.

As described above, in the disk drive apparatus 1, since the photo diode 19 serving as a detecting means is disposed in the rise mirror 12, the number of components of the optical pickup 7 and the disk drive apparatus 1 can be reduced, and also, since no exclusive space for disposing the photo diode 19 is needed, the sizes of the optical pickup 7 and the disk drive apparatus 1 can be reduced.

Also, since the photo diode 19 is disposed in the rise mirror 12, a laser beam transmitted through the half mirror 18 is effectively incident on the photo diode 19; and also, no collective lens for collecting a laser beam is needed, thereby further reducing the number of components and the sizes of the optical pickup 7 and the disk drive apparatus 1.

In addition, since the half mirror 18 is disposed across the entire irradiation region of the rise mirror 12 irradiated with a laser beam emitted from the light emitting element 11, the same flux part of a laser beam as that transmitted through the half mirror 18 toward the disk recording medium 100 is incident on the photo diode 19, whereby the photo diode 19 can improve the accuracy of controlling the output of the light emitting element 11.

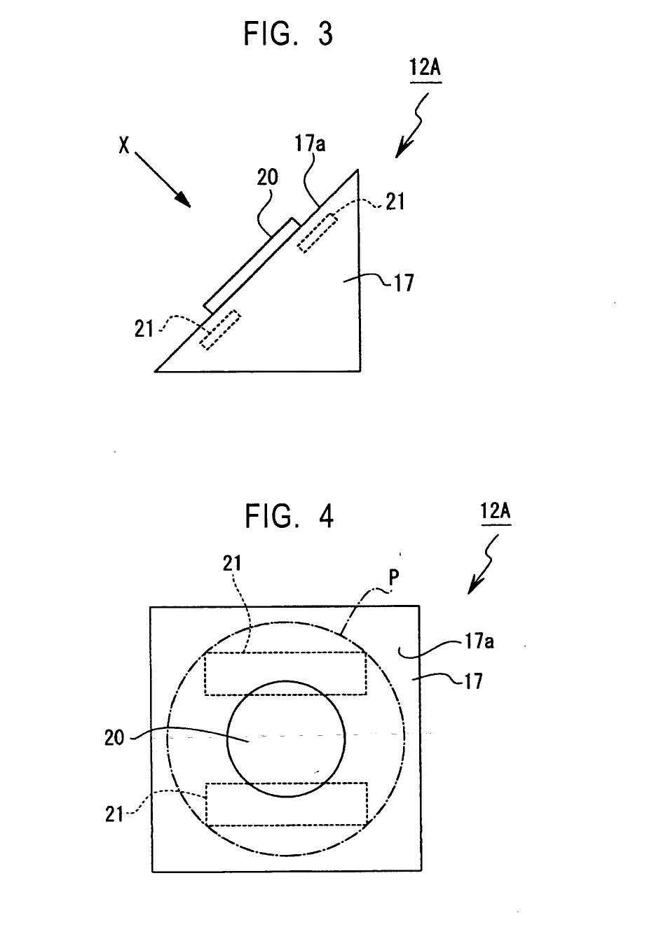

Each of modifications of the rise mirror will be described below (see FIGS. 3 to 8).

First, a rise mirror 12A as a first modification will be described (see FIGS. 3 and 4).

The rise mirror 12A has a main portion 17 having a triangular prism shape and a total reflecting mirror 20 serving as the mirror portion formed on the inclined surface 17a of the main portion 17.

The main portion 17 has two photo diodes 21 serving as detecting means disposed in a buried manner. The two photo diodes 21 are formed so as to have, for example, a rectangular shape and are disposed so as to be vertically spaced away from each other and to extend along the inclined surface 17a in the vicinity of the inclined surface 17a of the main portion 17. The two photo diodes 21 are composed of the same material as that of the main portion 17.

The total reflecting mirror 20 is formed so as to have, for example, a round shape and is disposed at the center of the inclined surface 17a (see FIG. 4). The total reflecting mirror 20 is disposed in a part of an irradiation region P (see FIG. 4) of the rise mirror 12 irradiated with a laser beam emitted from the light emitting element 11. Each of the two photo diodes 21 formed in the main portion 17 is almost entirely disposed in the remaining part of the irradiation region P where no total reflecting mirror 20 is disposed (see FIG. 4).

A part of a laser beam emitted from the light emitting element 11 is reflected at the total reflecting mirror 20 of the rise mirror 12A toward the disk recording medium 100. Meanwhile, the remaining part of the laser beam emitted from the light emitting element 11, which is not reflected at the total reflecting mirror 20, is partially incident on the two photo diodes 21 and its amount is detected, and, in accordance with the detected amount, the output of the light emitting element 11 is controlled so as to make the amount of the laser beam emitted from the light emitting element 11 constant.

As described above, in the rise mirror 12A as the first modification, since the two photo diodes 21 serving as detecting means are disposed in the main portion 17, the number of components of the optical pickup 7 and the disk drive apparatus 1 can be reduced, and also, since no exclusive space for disposing the two photo diodes 21 is needed, the sizes of the optical pickup 7 and the disk drive apparatus 1 can be reduced.

Also, since the two photo diodes 21 are disposed in the rise mirror 12A, a laser beam incident on the rise mirror 12A is effectively incident on the two photo diodes 21; and also, no collective lens for collecting a laser beam is needed, thereby further reducing the number of components and the sizes of the optical pickup 7 and the disk drive apparatus 1.

In addition, since the mirror portion (the total reflecting mirror 20) and the two photo diodes 21 can be made smaller, the production costs of the optical pickup 7 and the disk drive apparatus 1 can be reduced.

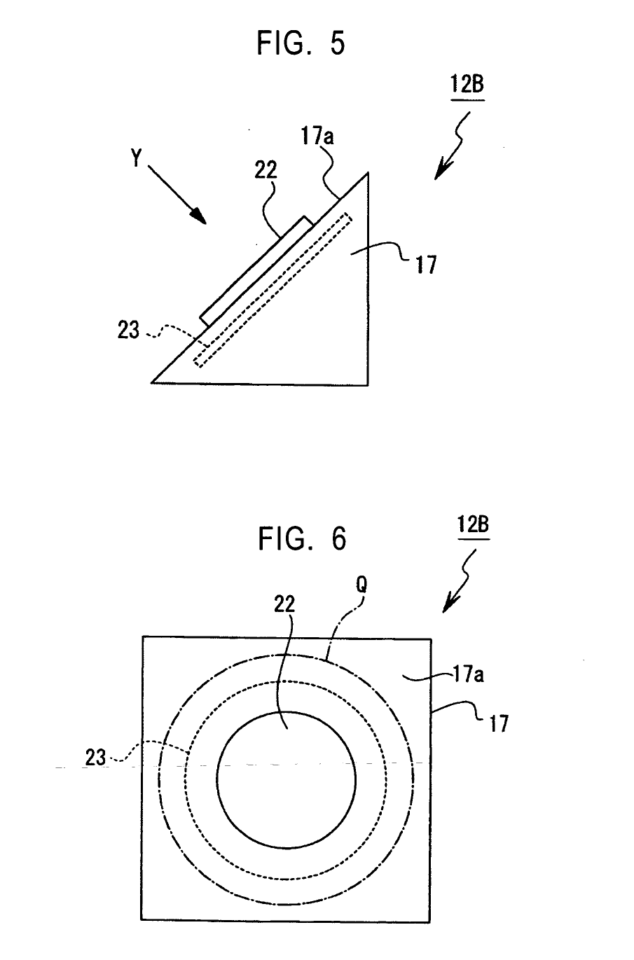

Next, a rise mirror 12B as a second modification will be described (see FIGS. 5 and 6).

The rise mirror 12B has a main portion 17 having a triangular prism shape and a total reflecting mirror 22 serving as the mirror portion formed on the inclined surface 17a of the main portion 17.

The main portion 17 has a photo diode 23 serving as detecting means and disposed in a buried manner. The photo diode 23 is formed to have, for example, a round shape, and is disposed to extend along the inclined surface 17a in the vicinity of the inclined surface 17a of the main portion 17. The photo diode 23 is composed of the same material as that of the main portion 17.

The total reflecting mirror 22 is formed to have, for example, a round shape smaller than the photo diode 23 and is disposed at the center of the inclined surface 17a (see FIG. 6). The total reflecting mirror 22 is disposed in a part of an irradiation region Q (see FIG. 6) of the rise mirror 12B, irradiated with a laser beam emitted from the light emitting element 11. The peripheral portion of the photo diode 23 formed in the main portion 17 is disposed in the remaining part of the irradiation region Q where no total reflecting mirror 22 is disposed (see FIG. 6).

Part of a laser beam emitted from the light emitting element 11 is reflected at the total reflecting mirror 22 of the rise mirror 12B toward the disk recording medium 100. Meanwhile, the remaining part of the laser beam emitted from the light emitting element 11, which is not reflected at the total reflecting mirror 22, is partially incident on the photo diode 23 and its amount is detected; and, in accordance with the detected amount, the output of the light emitting element 11 is controlled so as to make the amount of a laser beam emitted from the light emitting element 11 constant.

As described above, in the rise mirror 12B as the second modification, since the photo diode 23 serving as detecting means is disposed in the main portion 17, the number of components of the optical pickup 7 and the disk drive apparatus 1 can be reduced, and also, no exclusive space for disposing the photo diode 23 is needed, whereby the sizes of the optical pickup 7 and the disk drive apparatus 1 can be reduced.

Also, since the photo diode 23 is disposed in the rise mirror 12B, a laser beam incident on the rise mirror 12B is be effectively incident on the photo diode 23; and, also, no collective lens for collecting a laser beam is needed, thereby further reducing the number of components and the sizes of the optical pickup 7 and the disk drive apparatus 1.

In addition, the mirror portion (the total reflecting mirror 20) and the photo diode 23 can be made smaller, whereby the production costs of the optical pickup 7 and the disk drive apparatus 1 can be reduced.

The shapes and sizes of the total reflecting mirrors 20 and 22 and the photo diodes 21 and 23 of the foregoing rise mirrors 12A and 12B, respectively, have been illustrated by way of example. The shapes and sizes of a total reflecting mirror and detecting means are not limited to the above illustrated ones, and these components may have any shapes and sizes as long as the total reflecting mirror is disposed in a part of an irradiation region of the rise mirror and also, the photo diode is disposed in the remaining part of the irradiation region where the total reflecting mirror is not disposed.

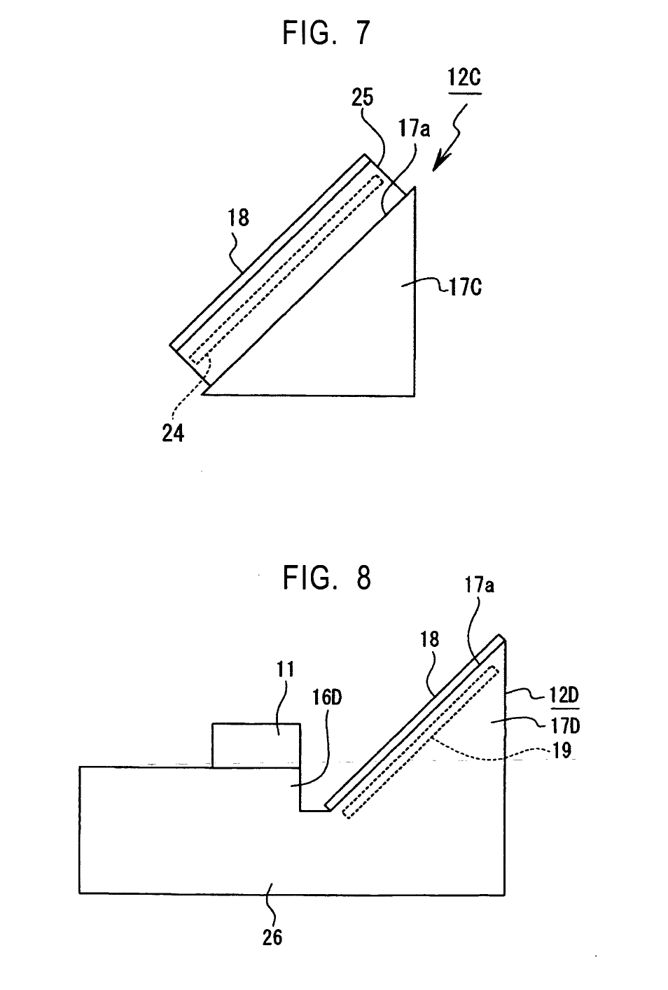

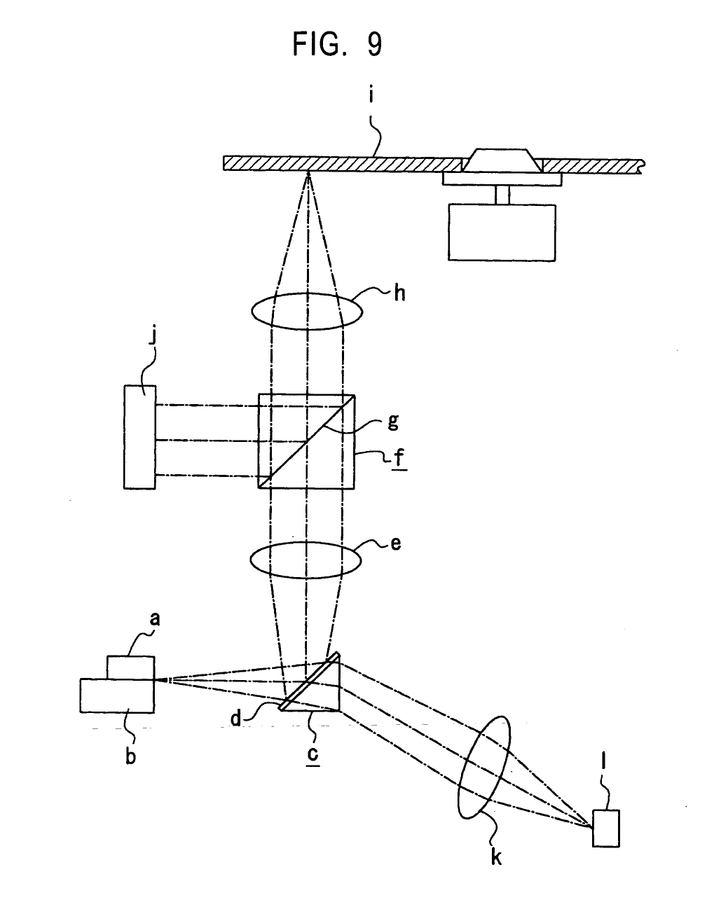

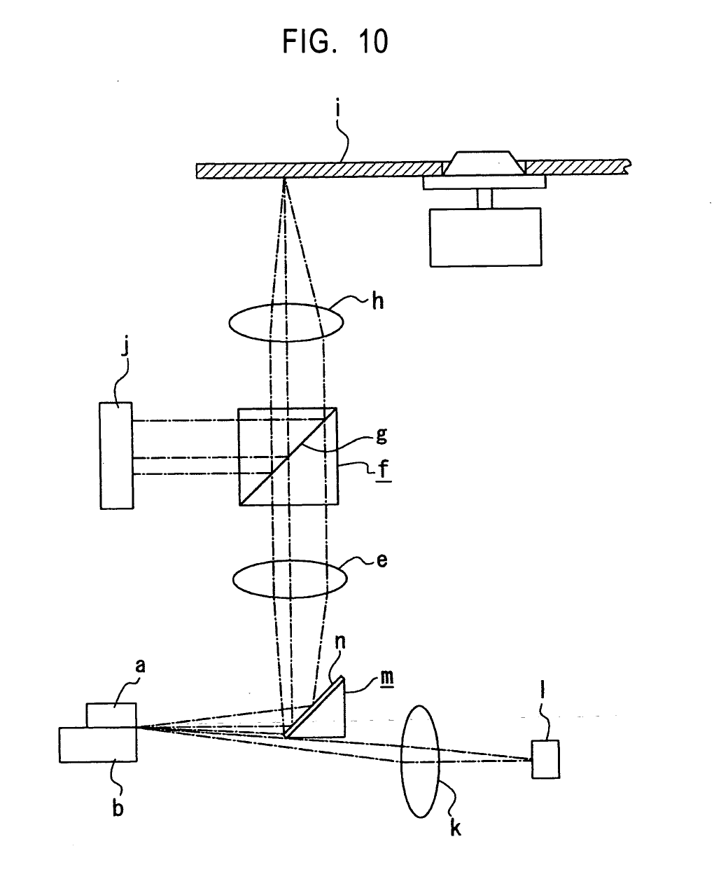

Although the foregoing rise mirrors 12, 12A, and 12B have the photo diodes 19, 21, and 23, respectively, formed in the main portion 17 in a buried manner, by way of example, as shown in FIG. 7, a rise mirror 12C may be formed such that a main portion 17C composed of, for example, a glass material or the like is used, and a flat semiconductor member 25 having a photo diode 24 disposed therein in a buried manner is bonded to the inclined surface 17a of the main portion 17C. In this case, the half mirror 18 or a part of the total reflecting mirror 20 is simply disposed on the semiconductor member 25.

Also, as shown in FIG. 8, a mount 16D and a main portion 17D of a rise mirror 12D may be formed into one unit having a connecting portion 26 interposed therebetween. In this case, the half mirror 18 or a part of the total reflecting mirror 20 is simply formed on the inclined surface 17a of the main portion 17D. By integrating the mount 16D, the main portion 17D, and the connecting portion 26 into one unit, the number of components and the production costs of the optical pickup 7 and the disk drive apparatus 1 can be reduced.

Any of the concrete shapes and structures of the components described in the foregoing embodiment are merely examples for implementing the present invention, and these examples shall not be construed to limit the technical scope of the present invention.

### INDUSTRIAL APPLICABILITY

As is obvious from the above description, an optical pickup according to the present invention that is provided with a moving base moving in the radial direction of a disk recording medium placed on a disk table and that is provided with predetermined optical elements and optical components disposed in the moving base includes a light emitting element for emitting a laser beam, a rise mirror including a main portion, having an inclined surface formed at a predetermined angle with respect to the optical axis of a laser beam emitted from the light emitting element, and a mirror portion formed on the inclined surface, for reflecting at least a part of the laser beam emitted from the light emitting element toward the disk recording medium, and a receiving optics for receiving the laser beam that is reflected at the rise mirror, with which the disk recording medium is subsequently irradiated, and which is then reflected at the disk recording medium. The rise mirror has at least one unit of detecting means disposed therein for receiving a part of the laser beam emitted from the light emitting element, for detecting the output of the received laser beam, and for outputting a signal for controlling the output of the light emitting element in accordance with the detected result.

Accordingly, since the rise mirror has the detecting means disposed therein, the number of components of the optical pickup can be reduced, and also, since no exclusive space for disposing the detecting means is needed, the size of the optical pickup can be reduced.

Also, since the rise mirror has the detecting means disposed therein, a laser beam incident on the rise mirror is effectively incident on the detecting means, and no collective lens for collecting a laser beam is needed, thereby further reducing the number of components and the size of the optical pickup.

Also, according to the present invention, since a half mirror for making a part of a laser beam emitted from the light emitting element incident on the main portion is used as the mirror portion, the half mirror is disposed across an entire irradiation region of the rise mirror, irradiated with the laser beam emitted from the light emitting element; and the detecting means is disposed in the main portion of the rise mirror, the same flux part of a laser beam as that transmitted through the half mirror toward the disk recording medium is incident on the detecting means, whereby the detecting means improves the accuracy for controlling the output of the light emitting element.

In addition, according to the present invention, since the mirror portion is disposed in a part of an irradiation region of the rise mirror, irradiated with a laser beam emitted from the light emitting element and the detecting means is disposed in at least a part of the remaining part of the irradiation region where no mirror portion is provided, the mirror portion and the detecting means can be made smaller, thereby reducing the production cost of the optical pickup.

Also, since the main portion and the detecting means are composed of the same material, the rise mirror can be formed very easily at a low cost.

Also, since the light emitting element is mounted on a circuit board, having a mount interposed therebetween, a connecting portion for connecting the mount and the main portion of the rise mirror is disposed, and the mount, the main portion, and the connecting portion are integrated into one unit, the number of components and the production cost of the optical pickup can be reduced.

A disk drive apparatus according to the present invention includes a disk table turned upon a disk recording medium being placed thereon; and an optical pickup which is provided with a moving base moving in the radial direction of the disk recording medium placed on the disk table and which is provided with predetermined optical elements and optical components disposed in the moving base. The optical pickup includes a light emitting element for emitting a laser beam, a rise mirror including a main portion, having an inclined surface formed at a predetermined angle with respect to the optical axis of a laser beam emitted from the light emitting element, and a mirror portion formed on the inclined surface, for reflecting at least a part of the laser beam emitted from the light emitting element toward the disk recording medium, and a receiving optics for receiving the laser beam that is reflected at the rise mirror, with which the disk recording medium is subsequently irradiated, and which is then reflected at the disk recording medium. The rise mirror has at least one unit of detecting means disposed therein for receiving a part of the laser beam emitted from the light emitting element, detecting the output of the received laser beam, and outputting a signal for controlling the output of the light emitting element in accordance with the detected result.

Accordingly, since the rise mirror has the detecting means disposed therein, the number of components of the optical pickup can be reduced; and also, since no exclusive space for disposing the detecting means is needed, the size of the disk drive apparatus can be reduced.

Also, since the rise mirror has the detecting means disposed therein, a laser beam incident on the rise mirror is effectively incident on the detecting means, and no collective lens for collecting a laser beam is needed, thereby further reducing the number of components and the size of the disk drive apparatus.

Also, since a half mirror for making a part of a laser beam emitted from the light emitting element incident on the main portion is used as the mirror portion, the half mirror is disposed across an entire irradiation region of the rise mirror, irradiated with the laser beam emitted from the light emitting element, and the detecting means is disposed in the main portion of the rise mirror, the same flux part of a laser beam as that transmitted through the half mirror toward the disk recording medium is incident on the detecting means, whereby the detecting means improves the accuracy for controlling the output of the light emitting element.

In addition, since the mirror portion is disposed in a part of an irradiation region of the rise mirror, irradiated with a laser beam emitted from the light emitting element, and the detecting means is disposed in at least a part of the remaining of the irradiation region where no mirror portion is provided, the mirror portion and the detecting means can be made smaller, thereby reducing the production cost of the disk drive apparatus.

Also, since the main portion and the detecting means are composed of the same material, the rise mirror can be very easily formed at a low cost.

Also, since the light emitting element is mounted on a circuit board, having a mount interposed therebetween a connecting portion for connecting the mount and the main portion of the rise mirror is disposed, and the mount, the main portion, and the connecting portion are integrated into one unit, the number of components and the production cost of the disk drive apparatus can be reduced.

1. An optical pickup which is provided with a moving base moving in the radial direction of a disk recording medium placed on a disk table and which is provided with predetermined optical elements and optical components disposed in the moving base, comprising:
a light emitting element for emitting a laser beam;
a rise mirror including a main portion, having an inclined surface formed at a predetermined angle with respect to the optical axis of a laser beam emitted from the light emitting element, and a mirror portion formed on the inclined surface, for reflecting at least a part of the laser beam emitted from the light emitting element toward the disk recording medium; and
a receiving optics for receiving the laser beam which is reflected at the rise mirror, with which the disk recording medium is subsequently irradiated, and which is then reflected at the disk recording medium,
wherein the rise mirror has at least one unit of detecting means disposed therein for receiving a part of the laser beam emitted from the light emitting element, for detecting the output of the received laser beam, and for outputting a signal for controlling the output of the light emitting element in accordance with the detected result.

2. The optical pickup according to claim 1, wherein
a half mirror for making a part of a laser beam emitted from the light emitting element incident on the main portion is used as the mirror portion;
the half mirror is disposed across an entire irradiation region of the rise mirror, irradiated with the laser beam emitted from the light emitting element; and
the detecting means is disposed in the main portion of the rise mirror.

3. The optical pickup according to claim 1, wherein
the mirror portion is disposed in a part of an irradiation region of the rise mirror, irradiated with a laser beam emitted from the light emitting element; and
the detecting means is disposed in at least a part of the remaining of the irradiation region where no mirror portion is provided.

4. The optical pickup according to claim 1, wherein the main portion and the detecting means are composed of the same material.

5. The optical pickup according to claim 1, wherein
the light emitting element is mounted on a circuit board, having a mount interposed therebetween;
a connecting portion for connecting the mount and the main portion of the rise mirror is disposed; and
the mount, the main portion, and the connecting portion are integrated into one unit.

6. A disk drive apparatus comprising: a disk table turned upon a disk recording medium being placed thereon; and an optical pickup which is provided with a moving base moving in the radial direction of the disk recording medium placed on the disk table and which is provided with predetermined optical elements and optical components disposed in the moving base,
the optical pickup comprising:
a light emitting element for emitting a laser beam;
a rise mirror including a main portion, having an inclined surface formed at a predetermined angle with respect to the optical axis of a laser beam emitted from the light emitting element, and a mirror portion formed on the inclined surface, for reflecting at least a part of the laser beam emitted from the light emitting element toward the disk recording medium; and
a receiving optics for receiving the laser beam which is reflected at the rise mirror, with which the disk recording medium is subsequently irradiated, and which is then reflected at the disk recording medium,
wherein the rise mirror has at least one unit of detecting means disposed therein for receiving a part of the laser beam emitted from the light emitting element, for detecting the output of the received laser beam, and for outputting a signal for controlling the output of the light emitting element in accordance with the detected result.

7. The disk drive apparatus according to claim 6, wherein
a half mirror for making a part of a laser beam emitted from the light emitting element incident on the main portion is used as the mirror portion;
the half mirror is disposed across an entire irradiation region of the rise mirror, irradiated with the laser beam emitted from the light emitting element; and
the detecting means is disposed in the main portion of the rise mirror.

8. The disk drive apparatus according to claim 6, wherein
the mirror portion is disposed in a part of an irradiation region of the rise mirror, irradiated with a laser beam emitted from the light emitting element; and
the detecting means is disposed in at least a part of the remaining of the irradiation region where no mirror portion is provided.

9. The disk drive apparatus according to claim 6, wherein the main portion and the detecting means are composed of the same material.

10. The disk drive apparatus according to claim 6, wherein
the light emitting element is mounted on a circuit board, having a mount interposed therebetween;
a connecting portion for connecting the mount and the main portion of the rise mirror is disposed; and
the mount, the main portion, and the connecting portion are integrated into one unit.
